(19) United States
(12) Patent Application Publication
(10) Pub. No.: US 2007/0248093 A1
(43) Pub. Date: Oct. 25, 2007

(54) Context information collection system, processing method thereof, and program storage medium storing program thereof

(75) Inventors: Shinya Yamamura, Fukuoka (JP); Shinichi Matsumoto, Fukuoka (JP); Masaaki Takase, Kawasaki (JP); Jun Maeda, Kawasaki (JP); Mitsuaki Kakemizu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/525,054

(22) Filed: Sep. 22, 2006

(30) Foreign Application Priority Data
Apr. 19, 2006 (JP) 2006-115895

(51) Int. Cl. H04L 12/56

(52) U.S. Cl. 370/392; 370/401

(57) ABSTRACT

A subscriber notifies a concentrator of a desired target identifier. An originator collects target identifiers received by a sensor which receives a target identifier transmitted from a target device. The originator transmits the collected target identifiers to the concentrator. The concentrator notifies the subscriber of the originator when the target identifiers transmitted from the originator includes the desired target identifier. The subscriber notifies the originator of a specification. The originator transmits a message to the subscriber in accordance with the specification, the message including the desired target identifier and other target identifiers received at about the same time as the desired target identifier.

### BACKGROUND OF THE INVENTION

1. Field of the Invention

The present invention relates to ubiquitous services, especially to techniques for efficiently filtering information in a large-scale context information collection system.

2. Description of the Related Art

As one of ubiquitous services, a context aware service holds promise of offering various conveniences by determining situations surrounding targeted persons/objects (referred to as target objects) and delivering appropriate information or performing automatic control of equipment. In order to extract necessary information out of an enormous amount of information detected by sensors, and to implement service in an appropriate response time, a technique for filtering information is important.

Studies are underway for the commercial viability of various ubiquitous services using sensors and/or RFID tags (radio frequency identifier tags; also referred to as “wireless tags”, “wireless IC tags”, “IC tags” or “non-contact IC chips”). Because many of the various ubiquitous services cover specific sensors and/or specific target objects, appropriate load distributions are possible in a closed system that is inherent to services.

In contrast, the context aware service is service for determining situations surrounding a target object to thereby allow actions of some kinds to be taken. The variety of sensors and objects covered by the context aware service is quite wide.

Many of the various context aware services are considered to cover daily lives or enterprise jobs. Since target objects (mainly persons) to which services are provided freely move to various places, more monitoring points are needed. As a result, applications for executing a context aware service cannot help collecting events from the sensors in the overall area covered by the service. This causes a problem in that information processing becomes congested by processing of a large amount of events transmitted by the sensors.

In actuality, the context information required by an application is only a context having a specific condition, and most of the events transmitted by the sensors are meaningless and invalid events for individual applications.

In order to reduce the number of events processed by the application, it is effective to select events at a place as close to a sensor as possible. However, setting up an enormous number of filters by applications at all times in the sensor creates a problem of reducing processing capacities of individual sensor managing servers.

A commonly-used method for implementing a context aware service is to extract necessary context information by searching in a gigantic database storing all sensor events (reception of a target identifier by a sensor) under various searching conditions. Another method under study is such one in which an event that is significant at an application level is extracted in real time by performing data mining on a stream of events.

However, since a search of such an approach basically becomes overall searching in database, and in addition, the number of target objects covered by the service overwhelmingly larger than that of sensors, it is evident that enormous calculation resources are required for event production.

A possible countermeasure against this is a method for securing scalability by subjecting a large amount of processing servers to load balancing. However, easily securing the scalability is not enough as the countermeasure, since it leads to an excess investment in calculation resources, and increases the possibility that it may become commercially unprofitable even if it can provide service.

Because many of the sensors used in the context aware service are permanently installed, they are manifested on a network. However, since target objects to be detected by the sensors move all the time, and may go outside a detection area, their manifestation property is not held. The information detected by the sensors is merely values such as IDs of wireless tags and temperatures, and these alone cannot be used for application for performing a context aware service. An application for performing a context aware service requires a special event referred to as an “application level event (also referred to as an ALE)” in which other target objects detected together with the relevant target object during a fixed time period by a sensor and/or an identifier of the sensor (referred to as a sensor identifier) is related to the identifier of the relevant target object (referred to as a target identifier). The ALE is produced in accordance with a specification specifying desired information (referred to as an ALE specification) transmitted by the application.

As compared with a common mobile network environment, the sensor network can be taken as a kind of mobility environment in which a target object can be correlated with a mobile terminal, and a sensor can be correlated with an access point. Therefore, constructing a system such that, upon the sensor's having detected a target identifier, the sensor managing server communicates with an appropriate application to thereby be able to directly exchange events with the application, would be effective even in a context aware service implementing system, just as in the case where the mobile IP (Internet Protocol) has brought scalability into IP mobility environments.

Hereinafter, problems of prior art will be described using an example of concrete and large-scale context aware services. Future possible large-scale context aware services may include a transportation guidance, shop introduction, navigation, etc. These services can be performed by grasping context information such as movements of persons and vehicles on the basis of sensors deployed at shops near major stations and/or bus stops, and intersections, etc.

FIG. 19 is a diagram showing an example of large-scale context aware service. Here, as an example, 1,000 of Japanese main busy streets are set as service providing areas (corresponding to 504-1 through 504-1000), and each of the areas is assumed to have 100 pieces of sensors on average (corresponding to 505-1 through 505-100). Application service providers (referred to as ASPs), which provide services, are also assumed to be 1,000 in number (corresponding to 503-1 through 503-1000). Application services include a transportation guidance, shop introduction, navigation for example.

A user attempting to receive services holds an RF tag (506-1 for example) having a reach of several meters to 10 meters. On receiving a service, the user registers in an ASP the identifier of the RF tag and information on communication device for receiving the service, from a personal computer (PC) or mobile phone over the WEB via the portal of the context aware service.

Upon receipt of the service registration from the user, the ASP judges situation surrounding the user, on the basis of identifiers regarding persons, vehicles and service tickets or the like all of which are collected from service providing areas, to thereby provide various services.

FIG. 20 is a diagram schematically showing a problem about context information collection by the existing scheme. Under such situations, when the context information is processed by the existing scheme, each application must process 100,000 events (1,000 places multiply 100 sensors) for each time period in order to search for all persons to be provided with services. However, in the ASPs that provide service by simply relating users to the sensor's places where the users were detected, if the users have been detected by only 1,000 sensors, the remaining 99,000 events would be meaningless, invalid events for the ASPs. In other words, the great majority of processing time would be spent for processing invalid events, for the purpose of providing services to the users who are present at only several percent of all area.

If the ASPs set up a filter in each individual sensor, the invalid events do not occur. However, if 1,000 ASPs set, in each individual sensor, information such as to filter the users to be provided with services, the sensors, in turn, would have to determine whether the target identifiers are valid or invalid, 1,000 times for each target object.

In mails or the WEB (world wide web) in widespread use on the Internet, communication partners are almost steady, so that a method is effective by which a client determines a communication destination using a search function and performs communications. However, in an environment including a sensor network for tracing freely moving target objects, since the client cannot specify where desired information is located, and the source origin of information always varies, the search function is not effective. Furthermore, from the viewpoint of the information providing side, contents of information published are merely an enumeration of identifiers, and can show no significance of contents to the search function. Hence, new communication establishing means that is not of conventional search type is needed as a basis for implementing a context aware service.

### SUMMARY OF THE INVENTION

Accordingly, it is an object of the present invention to provide a network system (referred to as an ALE network) that establishes, at high speed, a link between applications and the sensor managing server, prior to the execution of a context aware service.

The context aware service in the present invention is executed by two phases composed of a service preparation phase and service execution phase.

The service preparation phase comprises the following items [1] and [2].

[1] A sensor managing server detects a target identifier.

[2] With the target identifier as a key, the ALE network links an application with the sensor managing server, and the application requests the sensor managing server to register an ALE specification.

The service execution phase comprises the following items [3] and [4].

[3] In accordance with the ALE specification, the sensor managing server transmits an ALE to the application.

[4] In accordance with contents of the transmitted ALE, the application takes an action of some kind on the target object (or a sensor or other target objects contained in its context).

A system for collecting context information according to an aspect of the present invention can communicate with a sensor which receives a target identifier transmitted from a target device identified by the target identifier. The system includes an originator which collects the target identifier received by the sensor and transmits information related to the collected target identifiers; a subscriber which searches for a first desired target identifier; and a concentrator which finds, after received an order from the subscriber, the first desired target identifier among from the target identifiers collected by the originator and notifies the subscriber of the originator which collected the first desired target identifier. The subscriber orders the originator to find a second desired target identifier.

As described above, in the present invention, the concentrator mediates between the subscriber and the originator. The concentrator finds the desired target identifier searched by the subscriber among from the target identifiers collected by the originator and notifies the subscriber of the originator. After that, the subscriber directly communicates with the designated originator. Thus, each subscriber can find the desired target identifier without checking all the information from each originator. The concentrator can be specialized for finding the desired target identifier so that the subscriber can recognize the originator which detected the desired target identifier much faster than the subscriber searches by itself. In addition, each originator or each sensor under control of originators does not need to filter the target identifiers in accordance with each condition set by subscribers. Each originator only needs to filter the target identifier notified directly from the subscriber after the mediation by the concentrator.

This produces the effect of eliminating the need to process a large amount of events from irrelevant originators, and being capable of extracting significant information and providing service in an appropriate response time period, without the need for permanently setting up a filter.

A method according to another aspect of the present invention allows a system to execute a process of collecting context information. The system includes a subscriber, a concentrator and an originator. The system can communicate with a sensor which receives a target identifier transmitted from a target device. The method includes a step in which the subscriber transmits a first condition prescribing a first desired target identifier to the concentrator; a step in which the originator collects the target identifier received by the sensor; a step in which the originator transmits a first target identifier included in the collected target identifiers to the concentrator; and a step in which the concentrator determines whether the first target identifier satisfies the first condition.

A computer-readable storage medium according to another aspect of the present invention stores a program that allows a computer system to execute the method described above.

The above general description of the present invention is not an enumeration of characteristics essential to the present invention. The sub-combination of these plural characteristics can also constitute an invention.

With the above-described arrangements, filter information for producing events inherent to applications can be dynamically registered in the source origin of events. This eliminates for the applications having to process a large amount of invalid events that makes no sense to service provision.

Because the production of events on the basis of a filter is high load processing, and such dynamic registration reduces the total number of filters, thereby allowing the response of the overall system to be improved.

The present invention provides an implementing method for the context aware service covering objects freely moving in a network, thereby enabling a variety of context aware services to be provided by fewer calculation resources.

### BRIEF DESCRIPTION OF THE DRAWINGS

FIG. 1 is a system block diagram of the present invention;

FIG. 2A is a flowchart of an initial registration phase according to the present invention;

FIG. 2B is the system block diagram of FIG. 1 with indications of parts relating to steps described in FIG. 2A;

FIG. 3A is a flowchart of a link phase according to the present invention;

FIG. 3B is the system block diagram of FIG. 1 with indications of parts relating to steps described in FIG. 3A;

FIG. 4 is a functional block diagram of an ALE Originator constituting the present invention;

FIG. 5A is a flowchart showing operations of the ALE Originator;

FIG. 5B is the functional block diagram of FIG. 4 with indications of parts relating to steps described in FIG. 5A;

FIG. 6 is a representation of a data constructional example of a specification table;

FIG. 7 is a representation of a data constructional example of an event processing buffer;

FIG. 8 is a representation of a data constructional example of a destination table;

FIG. 9 is a functional block diagram of an ALE Concentrator constituting the present invention;

FIG. 10A is a flowchart showing operations of the ALE Concentrator;

FIG. 10B is the functional block diagram of FIG. 9 with indications of parts relating to steps described in FIG. 10A;

FIG. 11 is a representation of a data constructional example of a connection cashe (for the ALE Subscriber);

FIG. 12 is a representation of a data constructional example of a connection cashe (for the ALE Originator);

FIG. 13 is a representation of a data constructional example of an ALE routing table;

FIG. 14 is a functional block diagram of the ALE Subscriber constituting the present invention;

FIG. 15A is a flowchart showing operations of the ALE Subscriber;

FIG. 15B is the functional block diagram of FIG. 14 with indications of parts relating to steps described in FIG. 15A;

FIG. 16 is a representation of a data constructional example of a target ID list;

FIG. 17 is a representation of a data constructional example of a specification list;

FIG. 18 is a representation of an example of operations of collection and rejection of events;

FIG. 19 is a diagram showing an example of a large-scale context aware service;

FIG. 20 is a diagram schematically showing a problem about context information collection by the existing scheme;

FIG. 21 is a diagram schematically showing an effect according to the second embodiment of the present invention;

FIG. 22 is a diagram showing an explanatory system configuration of a bus guidance service according to a third embodiment of the present invention with indications of a processing sequence of connection to a public transportation information agency;

FIG. 23 is a diagram showing the explanatory system configuration of the bus guidance service according to the third embodiment of the present invention with indications of a processing sequence of detection of a user;

FIG. 24 is a diagram showing the explanatory system configuration of the bus guidance service according to the third embodiment of the present invention with indications of a processing sequence of navigation including boarding go/no-go information; and

FIG. 25 is a diagram showing a typical computer environment.

### DESCRIPTION OF THE PREFERRED EMBODIMENTS

Hereinafter, embodiments of the present invention will be described with reference to the accompanying drawings.

### First Embodiment

### [1. Construction of ALE Network]

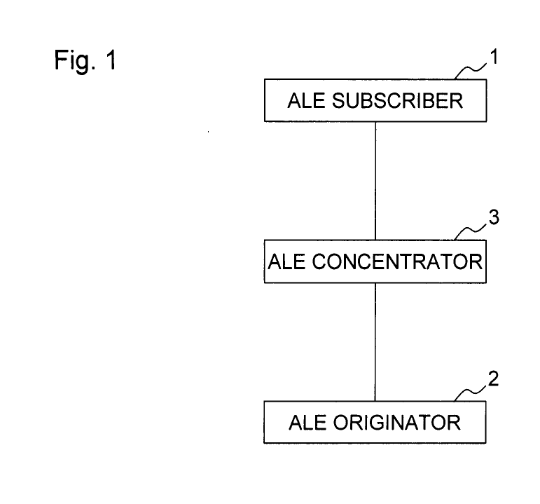

FIG. 1 is a system block diagram of the present invention.

An ALE network is a network for linking two entities through the medium of a target identifier. The ALE network comprises an ALE Originator 2 for transmitting an ALE, an ALE Subscriber 1 for making reference to the ALE and an ALE Concentrator 3 for connecting the ALE Subscriber 1 and ALE Originator 2 and forwarding a special ALE called an initial ALE from the ALE Originator 2 to the ALE Subscriber 1. The ALE network is a virtual network constructed on an IP network. In FIG. 1, while the ALE network is connected through the ALE Concentrator 3, devices are connected to the actual network so as to be able to communicate with one another. For convenience, the devices are each illustrated as a single piece. Although the ALE Concentrator 3 theoretically consists of a single piece, the ALE Subscriber 1 and ALE Originator 2 are each connected to the ALE Concentrator 3, as multiple pieces.

The device designated as ALE Originator 2 is one that detects a target identifier; edits a list of detected target identifiers in accordance with designated information; and transmits the list to a designated destination.

The device designated as ALE Subscriber 1 is one that selects an arbitrary target identifier; requests the ALE Concentrator 3 to register the selected target identifier; receives notification information including the target identifier from the ALE Concentrator 3; upon receipt of the above-described notification information, requests the ALE Originator 2 that has detected the target identifier to register the target identifier, a sensor identifier of the sensor that has detected the target identifier (referred to as a base sensor), a spatial extent from the base sensor and a time span; and extracts significant information from the edited list of target identifiers received from the ALE Originator 2. The edited list of target identifiers includes target identifiers detected by sensors located within the designated spatial extent from the base sensor in every designated time span.

The device designated as ALE Concentrator 3 is one that manages the target identifier desired by the ALE Subscriber 1; receives from the ALE Originator 2, an initial ALE which includes a list of target identifiers collected by the ALE Originator 2; and upon receipt of an initial ALE including a target identifier desired by an ALE Subscriber 1, forwards the initial ALE to the ALE Subscriber 1.

The service preparation phase performed on the ALE network further comprises an initial registration phase and link phase. The initial registration phase is a phase in which the ALE Subscriber 1 and ALE Originator 2 connect with the ALE Concentrator 3 in order to forward the initial ALE between the ALE Subscriber 1 and ALE Originator 2. Herein, the ALE Originator 2 is notified from the ALE Concentrator 3 of a notification method of the initial ALE, and the ALE Subscriber 1 requests the ALE Concentrator 3 to register a desired target identifier. On the other hand, the link phase is a phase in which the ALE Originator 2 establishes a link between the ALE Originator 2 and the ALE Subscriber 1 when the ALE Originator 2 detected the target identifier desired by the ALE Subscriber 1.

### [2. Outline of Operations of ALE Network]

### [2.1 Initial Registration Phase]

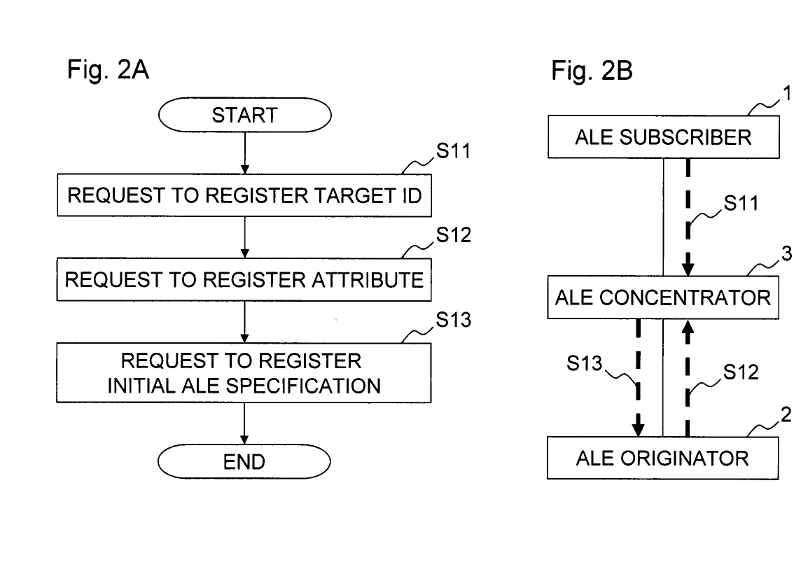

FIG. 2A is a flowchart of an initial registration phase according to the present invention. FIG. 2B is the system block diagram of FIG. 1 with indications of parts relating to steps described in FIG. 2A.

[step S11] An ALE Subscriber 1 requests the ALE Concentrator 3 to register a desired target identifier serving as a key constituent of the ALE and destination information of the ALE Subscriber 1. Upon receipt of a connection request from the ALE Subscriber 1, the ALE Concentrator 3 produces an ALE routing table for determining to which ALE Subscriber 1 an initial ALE including the designated target identifier is to be forwarded.

[step S12] An ALE Originator 2 requests the ALE Concentrator 3 to register an attribute information of the ALE Originator 2 (referred to as an Originator attribute). Details of the Originator attribute will be provided later.

[step S13] Upon receipt of a connection request from the ALE Originator 2, the ALE Concentrator 3 registers the transmitted Originator attribute. the ALE Concentrator 3 requests the ALE Originator 2 to register a specification of the initial ALE (referred to as an initial ALE specification) so as to be able to notify the ALE Concentrator 3 of a detected target identifier.

### [2.2 Link Phase]

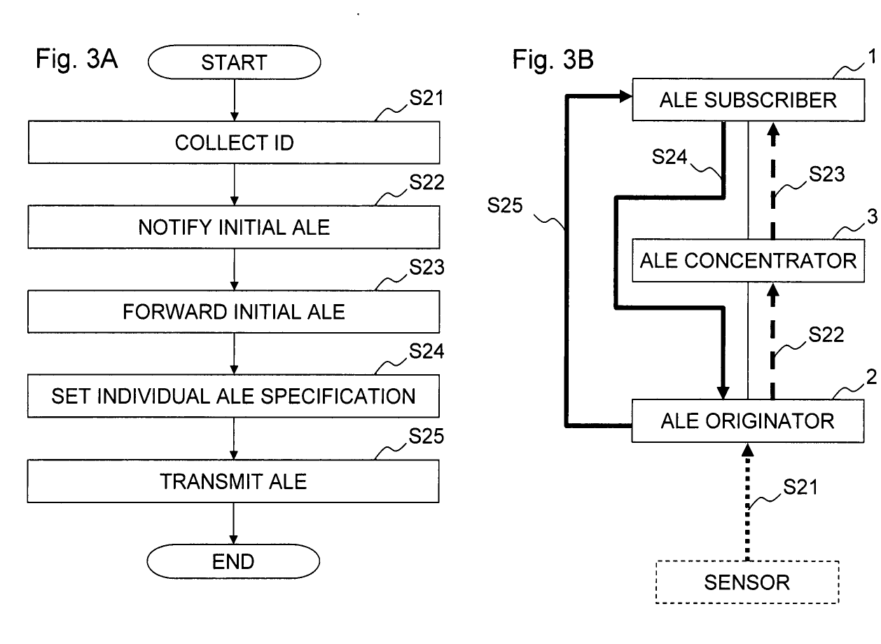

FIG. 3A is a flowchart of a link phase according to the present invention. FIG. 3B is the system block diagram of FIG. 1 with indications of parts relating to steps described in FIG. 3A.

[step S21] An ALE Originator 2 collects target identifiers received from sensors under control of the ALE Originator 2.

[step S22] The ALE Originator 2 transmits an initial ALE to the ALE Concentrator 3 in accordance with the initial ALE specification transmitted when the ALE Originator 2 connected with the ALE Concentrator 3.

[step S23] The ALE Concentrator 3 extracts target identifiers included in a list of target identifiers contained in the initial ALE; searches for the individual target identifiers in rooting tables; and upon finding a relevant entry, the ALE Concentrator 3 forwards the initial ALE to corresponding ALE Subscriber 1 together with an Originator attribute.

[step S24] The ALE Subscriber 1 determines, on the basis of contents of the transmitted initial ALE and the transmitted Originator attribute, whether an ALE is needed to be transmitted from the ALE Originator 2. Upon determining that the ALE is needed, the ALE Subscriber 1 determines an ALE specification, and requests the ALE Originator 2 to register the ALE specification.

[step S25] When there is an individual ALE specification provided by the ALE Subscriber 1, the ALE Originator 2 produces an ALE in accordance with the ALE specification, and directly transmits the ALE to the ALE Subscriber 1.

### [3. Detail of Operations of ALE Network]

### [3.1 ALE Originator]

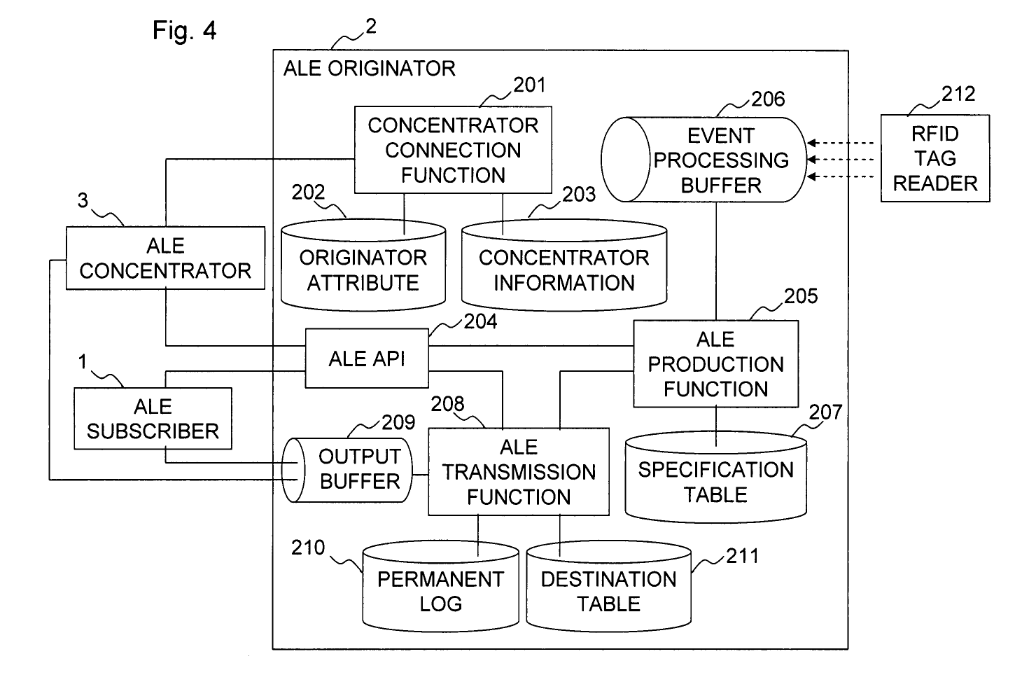

FIG. 4 is a functional block diagram of the ALE Originator 2. The ALE Originator 2 comprises a Concentrator connection function 201, ALE API (application programming interface) 204, ALE production function 205 and ALE transmission function 208.

The Concentrator connection function 201 is a function of transmitting a connection request to the ALE Concentrator 3, and requesting the ALE Concentrator 3 to register the Originator attribute used by an ALE Subscriber 1 to determine whether an ALE is needed or not. The Concentrator connection function 201 has an Originator attribute 202 and Concentrator information 203 as its data.

The Originator attribute 202 comprises place information of the sensor, event granularity, support specification for ALE, sensor property, and the like. The event granularity includes time granularity and spatial granularity. The time granularity means reading time period. The spatial granularity refers to one sensor alone, all sensors managed by the ALE Originator 2, a plurality of arbitrary sensors, or the like. The Concentrator information 203 includes an identifier of the ALE Concentrator 3 (referred to as a Concentrator identifier) and address information of the ALE Concentrator 3 (referred to as a Concentrator address) with which the ALE Originator 2 connects.

The ALE API 204 is an API for registering an ALE specification. An ALE Originator 2 registers an ALE specification in a specification table 207 on the basis of a specification registration request from the ALE Concentrator 3 or an ALE Subscriber 1. The ALE Originator 2 also registers the Concentrator identifier or an identifier of the ALE Subscriber 1 (referred to as a Subscriber identifier) as a notification destination, in a destination table 211 on the basis of a notification request.

The ALE production function 205 comprises an event processing buffer 206 and specification table 207. Target identifiers are detected, e.g., by an RFID tag reader 212 and stored in the event processing buffer 206 as sensor events. The sensor events accumulated in the event processing buffer 206 are edited as an ALE per reading period, for each ALE specification by the ALE production function 205 on the basis of a period and a filter tag identifier registered in the specification table 207.

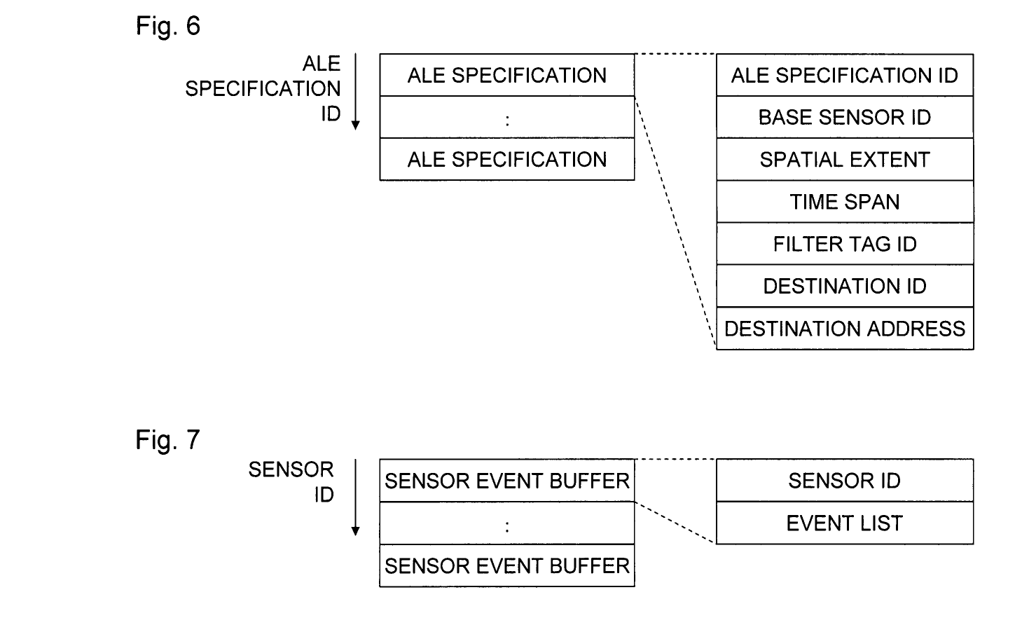

FIG. 6 shows a data constructional example of the specification table 207. The specification table 207 is indexed by an identifier of an ALE specification (referred to as an ALE specification identifier). The specification table 207 comprises, in each entry, the ALE specification identifier, an identifier of the base sensor(referred to as a base sensor identifier), a spatial extent from the base sensor for indicating a spatial range of search for sensor events, a time span for indicating a time range of search for sensor events, a filter tag identifier for indicating a target identifier to be detected, an identifier of a destination (referred to as a destination identifier) and an address of the destination (referred to as a destination address). The destination is an ALE Subscriber 1 or the ALE Concentrator 3. The ALE Originator 2 edits a list of target identifiers detected by sensors located within the designated spatial extent from the base sensor in designated time span and transmits the edited list to the destination.

FIG. 7 shows a data constructional example of the event processing buffer 206. The event processing buffer 206 is indexed by a sensor identifier. The event processing buffer 206 comprises, in each entry, the sensor identifier and an event list. In the event list, sensor event information of a fixed period is recorded in time order.

The ALE transmission function 208 comprises an output buffer 209, destination table 211 and permanent log 210. ALEs produced by the ALE production function 205 are accumulated in the output buffer 209. Making reference to the destination table 211, the accumulated ALEs are transmitted to the respective ALE Subscribers 1 or the ALE Concentrator 3. The transmitted ALEs are recorded in the permanent log 210 as its logs.

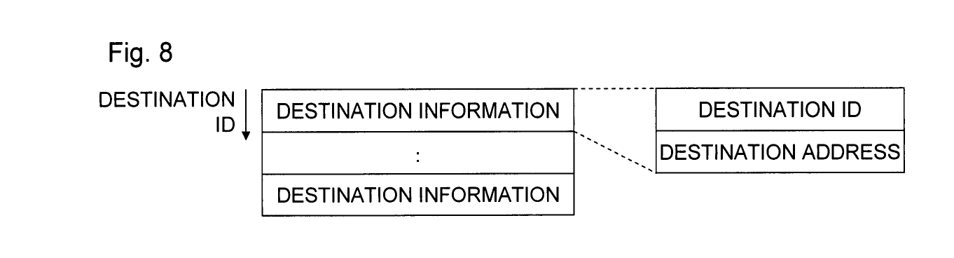

FIG. 8 shows a data constructional example of the destination table 211. The destination table 211 is indexed by a destination identifier. The destination table 211 comprises, in each entry, the destination identifier and a destination address.

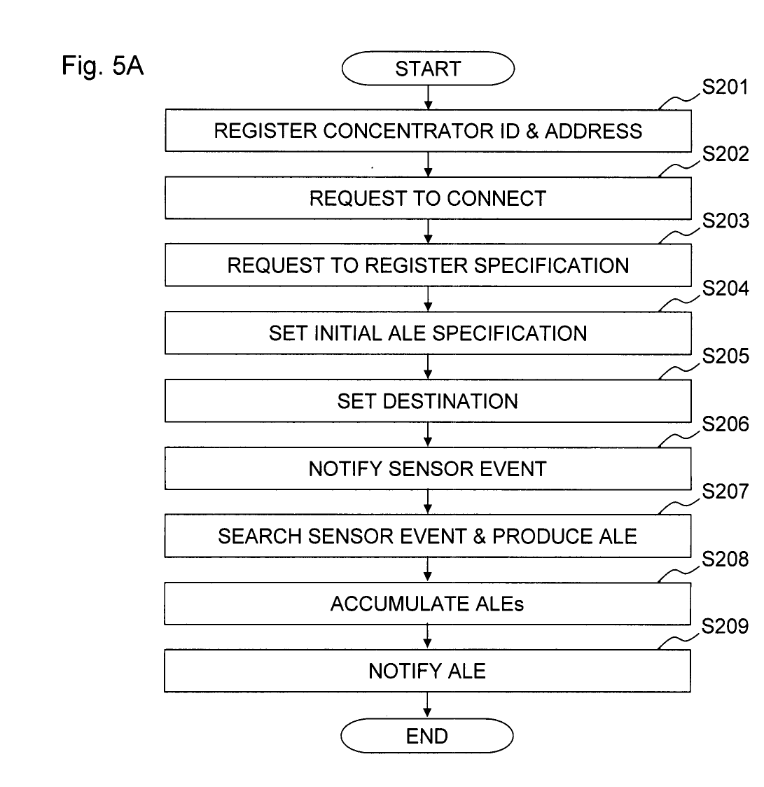

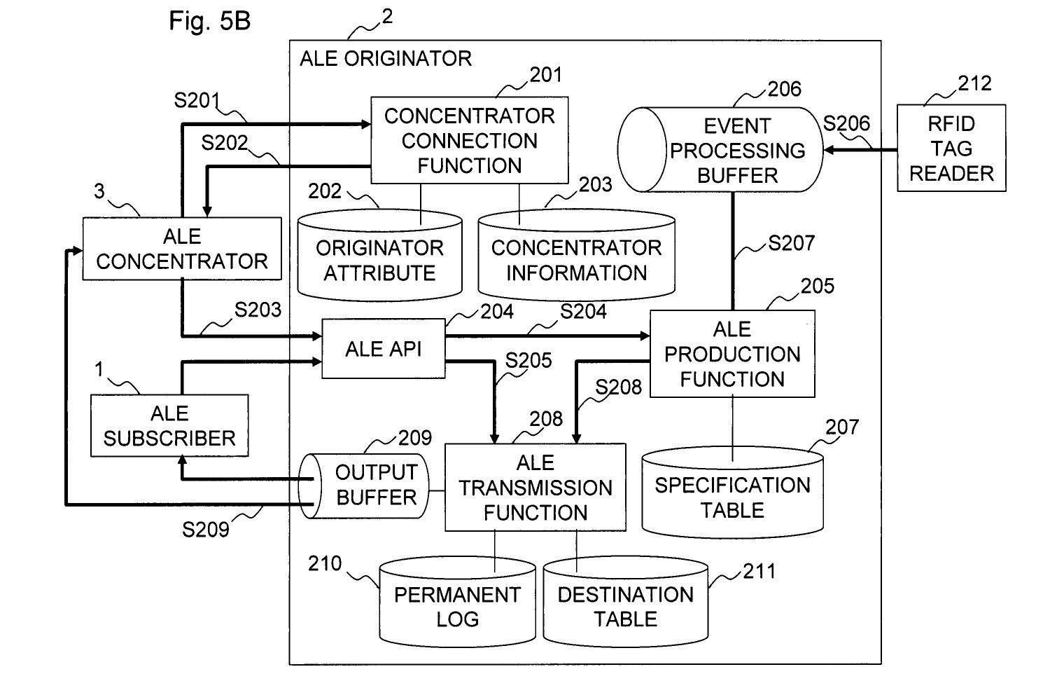

FIG. 5A is a flowchart showing operations of the ALE Originator 2. FIG. 5B is the functional block diagram of FIG. 4 with indications of parts relating to steps described in FIG. 5A.

Hereinafter, operations of the ALE Originator 2 will be described in accordance with the processing sequence shown in FIG. 5A.

[step S201] An ALE Originator 2 knows of the ALE Concentrator 3 and registers the Concentrator identifier and the Concentrator address as the Concentrator information 203. Possible methods to know the ALE Concentrator 3 includes: 1) the ALE Concentrator 3 makes aware the ALE Originator 2 of its presence by broadcasting its own Concentrator identifier and Concentrator address on the network; 2) the operator registers the Concentrator identifier and the Concentrator address in the ALE Originator 2 at an initial registration; and 3) the ALE Originator 2 dynamically searches for the ALE Concentrator 3 using a repository for searching services, or the like.

[step S202] The ALE Originator 2 transmits a connection request to the ALE Concentrator 3. The connection request includes an Originator attribute. The Originator attribute includes an identifier of the ALE Originator 2 (referred to as an Originator identifier) necessary for the ALE Concentrator 3 to send back an initial ALE specification and information for the ALE Subscriber 1 to determine whether an individual ALE specification is to be registered, e.g., place information, an event granularity, support specification for ALE and sensor property.

[step S203] Upon receipt of the connection request from the ALE Originator 2, the ALE Concentrator 3 requests the ALE Originator 2 to register an initial ALE specification and to notify of an initial ALE, so that the ALE Originator 2 can transmit the initial ALE to the ALE Concentrator 3. Consequently, the ALE Concentrator 3 can find a target identifier requested from an ALE Subscriber 1.

[step S204] Registration of the initial ALE specification is performed via the ALE API 204. The details of the ALE API 204 depend on the employed ALE system. The initial ALE specification transmitted is registered in the specification table 207 of the ALE production function 205.

[step S205] The information of the ALE Concentrator 3 as the requester of the initial ALE included in the notification request is registered in a destination table 211 of the ALE transmission function 208.

[step S206] Upon detection of target identifiers, the RFID tag reader 212 notifies the ALE Originator 2 of the target identifiers, as sensor events. The sensor events are bundled for each reading period and accumulated in the event processing buffer 206. If sensor events exceeding a buffer size are accumulated, old sensor events are paged out of the buffer one by one. The sensor events having been paged out are rejected, or recorded in the permanent log 210.

[step S207] The ALE production function 205 produces ALEs on the basis of the sensor events accumulated in the event processing buffer 206 in accordance with the specification table 207. The respective initial ALE specifications have arbitrary reading periods and filter tag identifiers. The search for the target identifiers in the event processing buffer 206 is performed individually for each of all initial ALE specifications.

[step S208] The ALEs produced by the ALE production function 205 are accumulated in the output buffer 209 of the ALE transmission function 208. The ALEs processed in the output buffer 209 is swept out into the permanent log 210 as its logs.

[step S209] The ALE transmission function 208 transmits the ALE to the ALE Subscriber 1, making reference to the destination table 211. A plurality of ALE Subscriber 1 can be registered for each ALE. An ALE based on an initial ALE specification is transmitted to the ALE Concentrator 3.

### [3.2 ALE Concentrator]

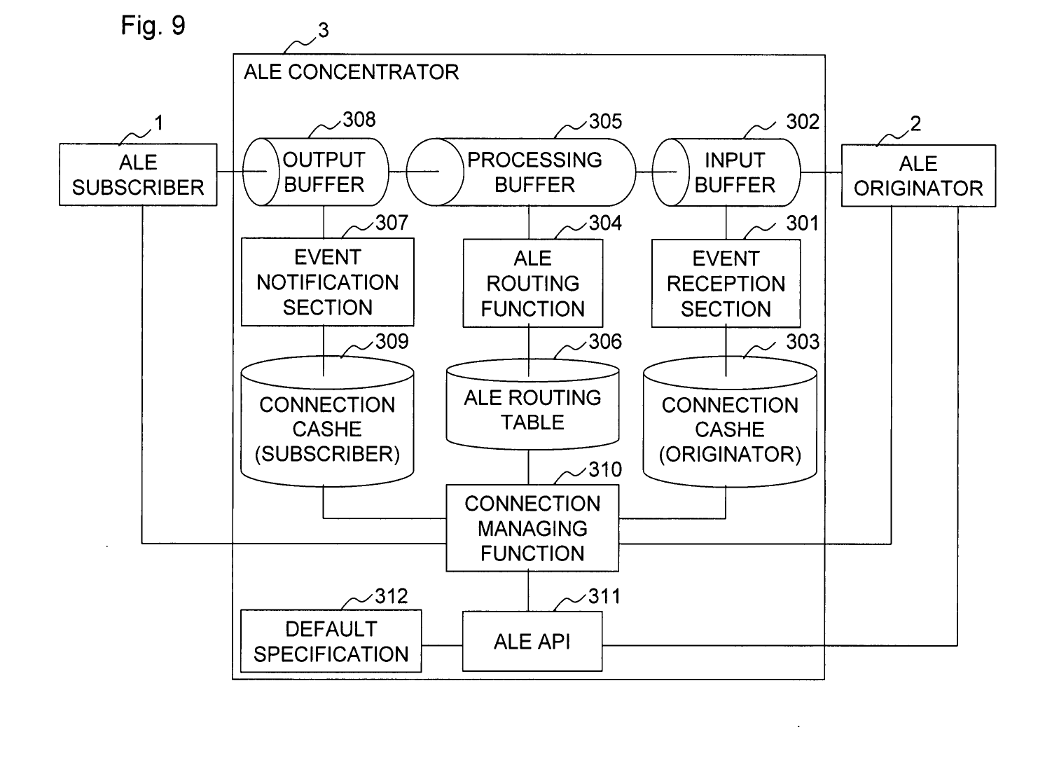

FIG. 9 is a functional block diagram of the ALE Concentrator 3. The ALE Concentrator 3 searches for target identifiers in an event list included in an initial ALE received from the ALE Originator 2, and forwards the initial ALE to the ALE Subscriber 1 desiring information of the target identifier. The ALE Concentrator 3 has a function specialized in the forwarding of a large amount of initial ALEs, and produces no ALE other than initial ALEs.

The ALE Concentrator 3 comprises an ALE API 311, connection managing function 310, event reception section 301, ALE routing function 304 and event notification section 307.

The ALE API 311 is an API for registering an ALE specification. In response to a connection request from the ALE Originator 2, the ALE Concentrator 3 requests the ALE Originator 2 to register an initial ALE specification and to transmit an initial ALE based on the initial ALE specification to the ALE Concentrator 3.

The connection managing function 310 comprises a connection cashe 303 for the ALE Originator 2, a connection cashe 309 for the ALE Subscriber 1 and ALE routing table 306, as its data. The connection managing function 310 accepts a connection request from the ALE Originator 2 or ALE Subscriber 1, and registers information included in the connection request in the connection cashe 303, the connection cashe 309 and the ALE routing table 306.

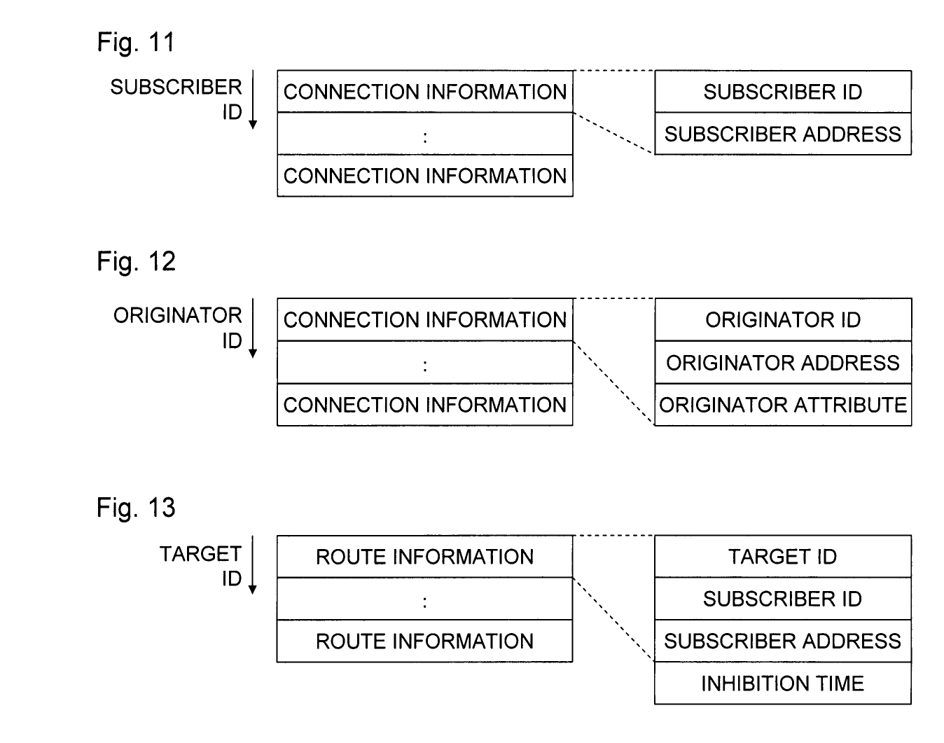

FIG. 11 shows a constructional example of the connection cashe 309 for the ALE Subscriber 1. The connection cashe 309 for the ALE Subscriber 1 is indexed by a Subscriber identifier, and each entry thereof includes the Subscriber identifier and an address of the ALE Subscriber 1 (referred to as a Subscriber address).

FIG. 12 shows a constructional example of the connection cashe 303 for the ALE Originator 2. The connection cashe 303 for the ALE Originator 2 is indexed by the Originator identifier, and each entry thereof includes the Originator identifier, an address of the ALE Originator 2 (referred to as an Originator address) and an Originator attribute transmitted from the ALE Originator 2.

FIG. 13 shows a constructional example of the ALE routing table 306. The ALE routing table 306 is indexed by the target identifier, and each entry thereof is constituted of the target identifier, a Subscriber identifier, a Subscriber address, and inhibition time for inhibiting the forwarding of an initial ALE for a fixed time after some initial ALE has been forwarded to the ALE Subscriber 1.

The event reception section 301 has an input buffer 302; accepts an initial ALE from an ALE Originator 2; extracts an Originator attribute from the connection cashe 303 for the ALE Originator 2; and adds the Originator attribute to the initial ALE.

The ALE routing function 304 has a processing buffer 305; extracts individual target identifiers from an event list which is the contents of the initial ALE inputted into the processing buffer 305; and searches for the extracted target identifiers in the ALE routing table 306. If a matched target identifier is found, the ALE routing function 304 adds a Subscriber identifier to a header of the initial ALE as a destination.

The event notification section 307 has an output buffer 308 and forwards the initial ALE to an ALE Subscriber 1, making reference to the header of the initial ALE inputted into the output buffer 308.

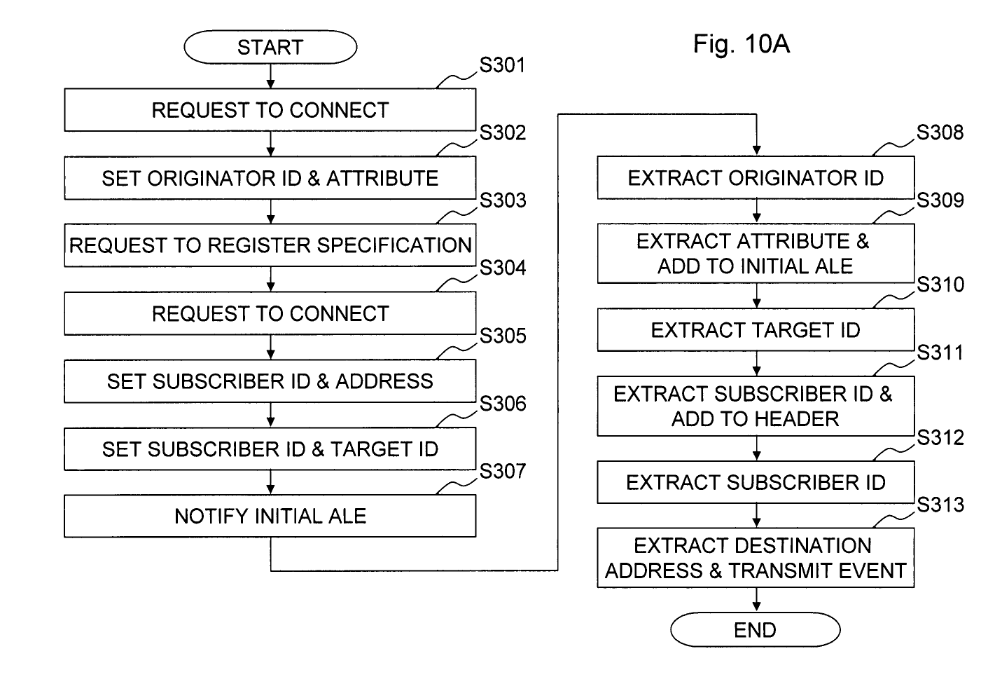

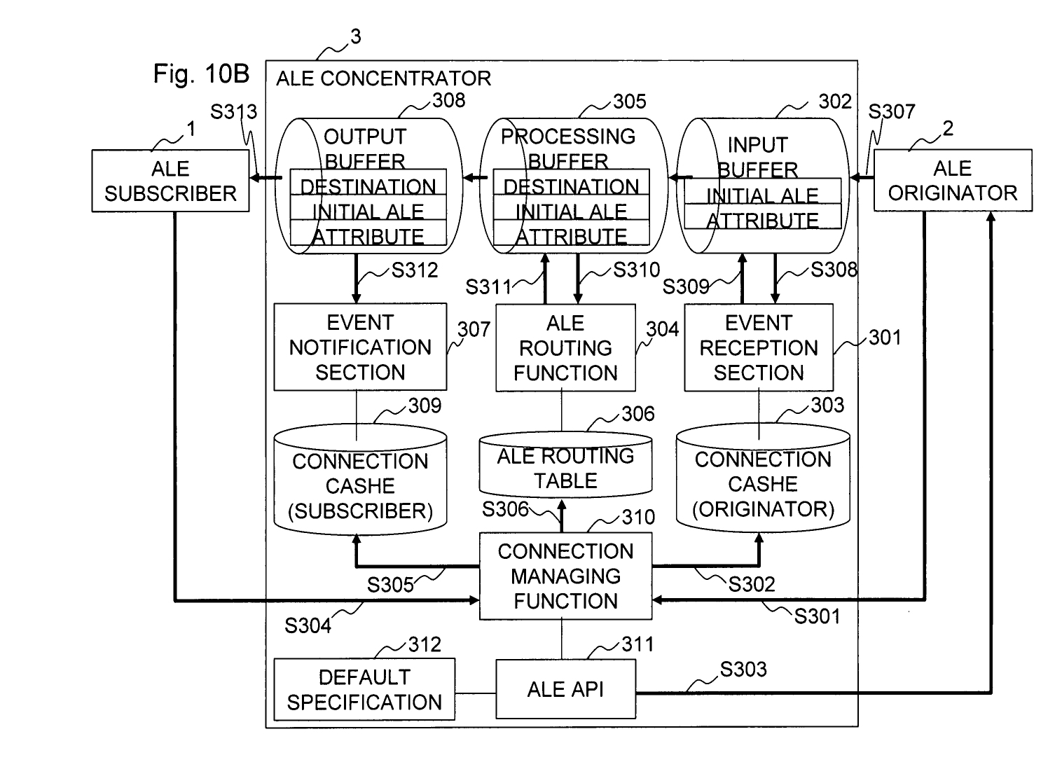

FIG. 10A is a flowchart showing operations of the ALE Concentrator 3. FIG. 10B is the functional block diagram of FIG. 9 with indications of parts relating to steps described in FIG. 10A.

Hereinafter, operations of the ALE Concentrator 3 will be described in accordance with the sequence shown in FIG. 10A.

[step S301] An ALE Originator 2 makes a connection request to the ALE Concentrator 3. Information contained in the connection request consists of an Originator identifier and an Originator attribute thereof.

[step S302] The connection managing function 310 accepts the connection request from the ALE Originator 2, and registers the information included in the connection request in a connection cashe 303 for the ALE Originator 2. The information to be stored in the connection cashe 303 for the ALE Originator 2 consists of the Originator identifier and the Originator attribute thereof.

[step S303] Using the ALE API 311, the connection managing function 310 requests the ALE Originator 2 that has transmitted the connection request, to register an initial ALE specification and to transmit an initial ALE based on the initial ALE specification to the ALE Concentrator 3. Consequently, the ALE Originator 2 can transmit an initial ALE to the ALE Concentrator 3.

[step S304] The ALE Subscriber 1 makes a connection request to the ALE Concentrator 3. Information contained in the connection request consists of a Subscriber identifier, a Subscriber address, a target identifier serving as a key to the ALE production and an inhibition time for controlling the notification frequency of initial ALEs.

[step S305] The connection managing function 310 accepts a connection request from an ALE Subscriber 1, and registers the information included in the connection request in the connection cashe 309 for the ALE Subscriber 1. Information to be stored in the connection cashe 309 for the ALE Subscriber 1 consists of a Subscriber identifier and a Subscriber address as the destination of an ALE.

[step S306] The connection managing function 310 registers in an ALE routing table 306, the Subscriber identifier, the Subscriber address, the target identifier, and inhibition time that are contained in the connection request message from the ALE Subscriber 1. The ALE routing table 306 is a table to be indexed by the target identifier, and stores information on the ALE Subscriber 1 as a destination.

[step S307] The ALE Originator 2 transmits an initial ALE in accordance with the initial ALE specification to the ALE Concentrator 3.

[step S308] The event reception section 301 registers the initial ALE in the input buffer 302; extracts an Originator identifier from the initial ALE; and searches for the Originator identifier in the connection cashe 303 for the ALE Originator 2.

[step S309] The event reception section 301 extracts an Originator attribute from the connection cashe 303 for the ALE Originator 2, and adds the Originator attribute to the initial ALE stored in the input buffer 302.

[step S310] The initial ALE processed in the event reception section 301 is outputted to the processing buffer 305. The ALE routing function 304 extracts target identifiers from the event list included in the initial ALEs inputted into the processing buffer 305, and checks whether each individual target identifier has been registered in the ALE routing table 306. If no relevant is found in the ALE routing table 306, the initial ALEs are rejected.

[step S311] On the other hand, if a relevant target identifier is found in the ALE routing table 306, the Subscriber identifier registered in the ALE routing table 306 is added to a header of the initial ALE. If an inhibition time for the corresponding ALE Subscriber 1 is other than 0, event editing processing is skipped, and the inhibition time is reduced. If the inhibition time is 0, the event editing processing is executed, and the value of a timer is reset. This produces the effect of eliminating for the ALE Subscriber 1 having to receive unnecessary information from the ALE Concentrator 3.

[step S312] The initial ALE with the Subscriber identifier in its header is outputted to the output buffer 308. The event notification section 307 extracts the Subscriber identifier from the header of the initial ALE inputted into the output buffer 308, and searches for the Subscriber identifier in the connection cashe 309 for the ALE Subscriber 1.

[step S313] The event notification section 307 transmits the event to the destination extracted from the connection cashe 309 for the ALE Subscriber 1.

### [3.3 ALE Subscriber]

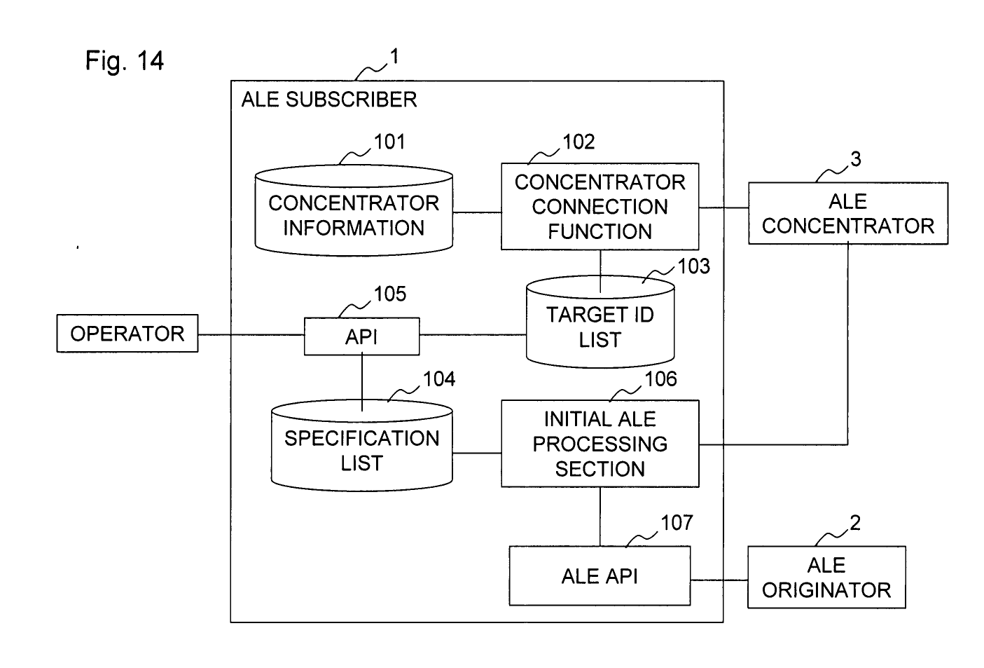

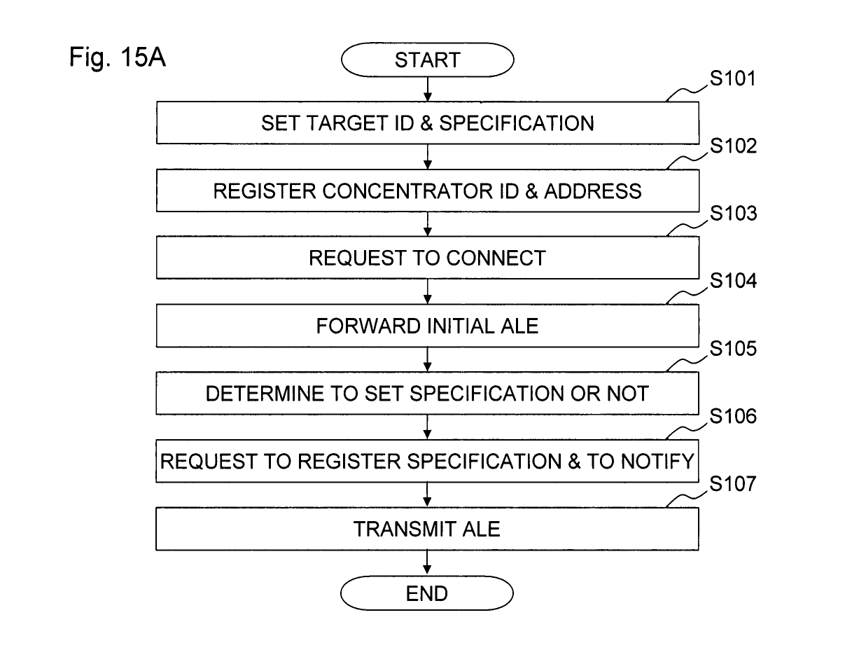

FIG. 14 is a functional block diagram of the ALE Subscriber 1. The ALE Subscriber 1 comprises an API 105, Concentrator connection function 102, initial ALE processing section 106 and ALE API 107.

The API 105 is an application interface for registering target identifiers and ALE specifications in a list so that the application can collect contexts.

The Concentrator connection function 102 is a function of notifying the ALE Concentrator 3 of a desired target identifier and requesting the ALE Concentrator 3 to forward an initial ALE to the ALE Subscriber 1. The Concentrator connection function 102 has Concentrator information 101 and a target ID list 103 as its data.

The Concentrator information 101 includes the Concentrator identifier and the Concentrator address with which the ALE Subscriber 1 connects.

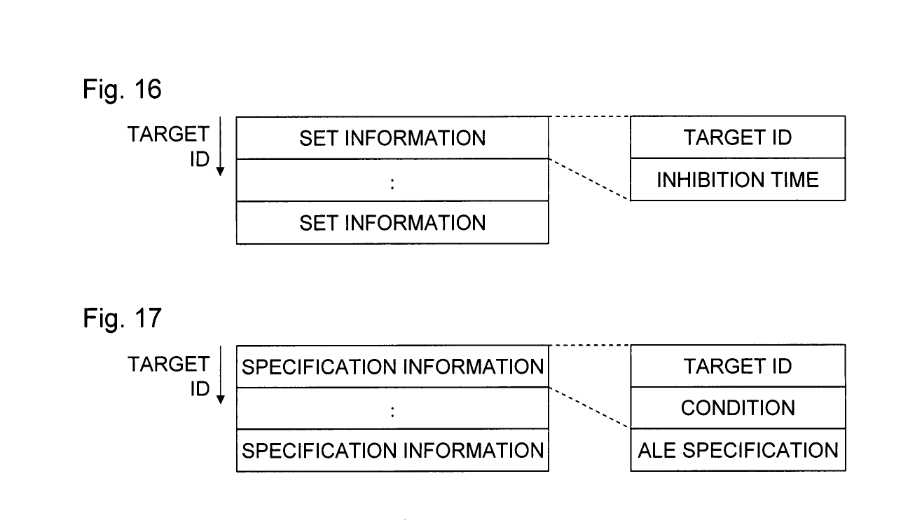

FIG. 16 shows a constructional example of a target ID list 103. The target ID list 103 is indexed by a target identifier, and each entry thereof includes the target identifier and inhibition time registered in the ALE Concentrator 3.

The initial ALE processing section 106 determines whether an ALE specification is to be registered in the ALE Originator 2 which is a source origin of the initial ALE forwarded from the ALE Concentrator 3. The initial ALE processing section 106 has a specification list 104 as its data.

FIG. 17 shows a constructional example of a specification list 104. The specification list 104 is indexed by a target identifier, and each entry thereof comprises the target identifier, a condition and an ALE specification. Here, the condition refers to, e.g., granularity of the occurrence of an initial ALE, place, necessary censor property and necessary time slot. The ALE specification is the same as that shown in FIG. 6.

The ALE API 107 is an API for registering an ALE specification. When the initial ALE processing section 106 determines specification registration in the ALE Originator 2, specification registration and direct transmission of an ALE to the ALE Subscriber 1 are requested to the ALE Originator 2. Here, the ALE Subscriber 1 receives the ALE transmitted from the ALE Originator 2 through this API.

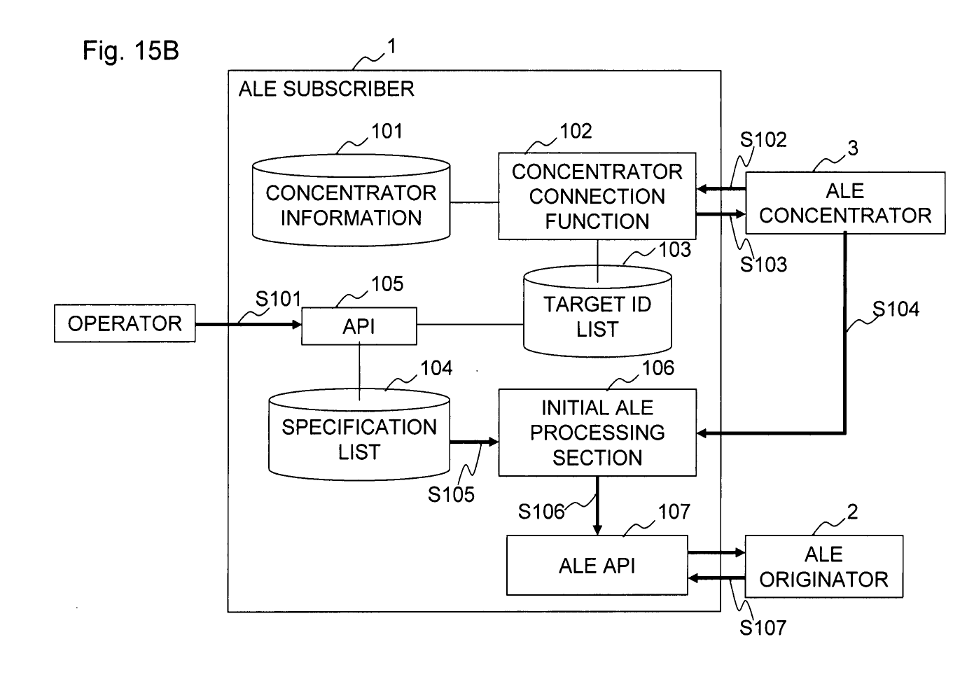

FIG. 15A is a flowchart showing operations of the ALE Subscriber 1. FIG. 15B is the functional block diagram of FIG. 14 with indications of parts relating to steps described in FIG. 15A.

Hereinafter, operations of the ALE Subscriber 1 will be described in accordance with the sequence shown in FIG. 15A.

[step S101] An external application using the ALE Subscriber 1 requests, via the API 105, the ALE Subscriber 1 to register a list of target identifiers and corresponding ALE specifications. Otherwise, an operator registers the list in the ALE Subscriber 1. The target identifiers and the corresponding ALE specifications are registered in the target ID list 103 and specification list 104, respectively.

[step S102] The ALE Subscriber 1 knows of the ALE Concentrator 3 and registers the Concentrator identifier and the Concentrator address as the Concentrator information 101. Possible methods to know the ALE Concentrator 3 includes: 1) the ALE Concentrator 3 makes aware the ALE Subscriber 1 of its presence by broadcasting its own Concentrator identifier and Concentrator address on the network; 2) the operator registers the Concentrator identifier and the Concentrator address in the ALE Subscriber 1 at an initial registration; and 3) the ALE Subscriber 1 dynamically searches for the ALE Concentrator 3 using a repository for searching services, or the like.

[step S103] The ALE Subscriber 1 makes a connection request to the ALE Concentrator 3. Information contained in the connection request includes the Subscriber identifier and a list of desired target identifiers. The desired target identifiers are extracted from the target ID list 103.

[step S104] Upon detection of the target identifier designated by the ALE Subscriber 1, the ALE Concentrator 3 forwards an initial ALE including the target identifier to the ALE Subscriber 1.

[step S105] Upon receipt of the initial ALE from the ALE Concentrator 3, the initial ALE processing section 106 compares an Originator attribute included in the initial ALE with conditions of ALE specifications registered in the specification list 104, and determines whether one of the ALE specifications is to be registered in the ALE Originator 2. Here, the condition refers to, e.g., granularity of the occurrence of an initial ALE, place, necessary censor property and necessary time slot.

[step S106] When the Originator attribute satisfies a condition of an ALE specification, the initial ALE processing section 106, via the ALE API 107, requests the ALE Originator 2 to register the ALE specification and to notify in accordance with the specification. Thus, the Originator attribute is transmitted from the ALE Originator 2 through the ALE Concentrator 3 to the ALE Subscriber 1, and before the registration of the specification in the ALE Originator 2, the ALE Subscriber 1 determines whether information from the ALE Originator 2 could be significant information, using the Originator attribute. This produces the effect of allowing desired information necessary for service to be effectively collected.

[step S107] The ALE Originator 2 which has registered the ALE specification transmits an ALE directly to the ALE Subscriber 1. As shown in FIG. 6, the specification includes a base sensor identifier and a spatial extent from the base sensor. The ALE Originator 2 accumulates target identifiers detected by not only the base sensor but also other sensors located around the base sensor within the spatial extent. This produces the effect of allowing quick processing despite movements of targets, thereby to prevent delay.

### [3.4 Collection and Rejection of Events]

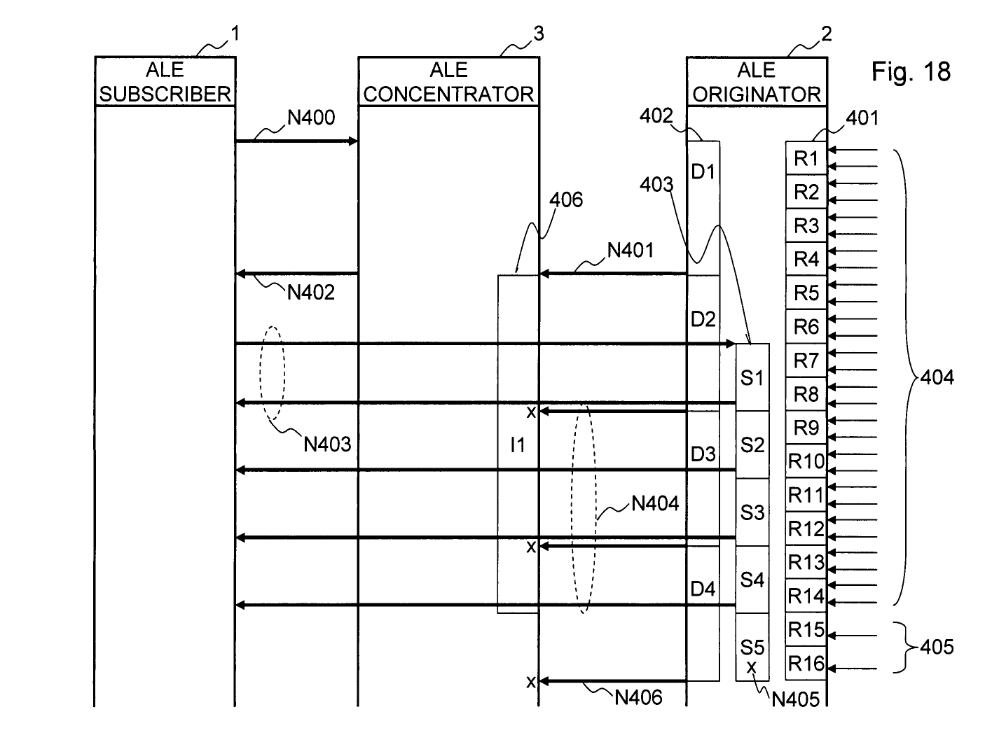

FIG. 18 is a representation of an example of operations of collection and rejection of events, which shows relationship between an initial ALE and an ALE other than initial ALEs. Data transmission among ALE Subscriber 1, ALE Originator 2 and ALE Concentrator 3 are placed in time order from the top to the bottom.

[note N400] It is assumed that an ALE Subscriber 1 designates a target identifier ID1 when connected to the ALE Concentrator 3.

[note N401] In an ALE Originator 2, Rx 401 refers to a reading period of a sensor; Dx 402 refers to a notification period designated in an initial ALE specification; and Sx 403 refers to a notification period designated in an ALE specification. It is assumed that two target objects having target identifiers ID1 and ID2 respectively now exist under control of the ALE Originator 2 and that the ID1 and ID2 are detected in its each reading period. In this example, initial ALEs are registered so as to be transmitted with four reading periods as a unit. For example, in the first notification period D1, the ALE Originator 2 notifies the ALE Concentrator 3 of an initial ALE including target identifiers detected in R1 to R4, i.e., ID1 and ID2.

[note N402] In the ALE Concentrator 3, the Ix 406 refers to an inhibition time for notification designated by the ALE Subscriber 1. Because the ID1 desired by the ALE Subscriber 1 has been registered in the ALE Concentrator 3, the ALE Concentrator 3 forwards this initial ALE to the ALE Subscriber 1. In order to prevent the initial ALE from being successively forwarded to the ALE Subscriber 1, the ALE Concentrator 3 blocks the forwarding of the initial ALE to the ALE Subscriber 1 for the inhibition time.

[note N403] The ALE Subscriber 1 to which the initial ALE has been forwarded, requests the ALE Originator 2 which has originally transmitted the initial ALE, to register an ALE specification. In this example, the ALE specification is registered in the ALE Originator 2 before a reading period R7, and the notification period of ALE is assumed to be two reading periods. Hence, in the notification period S1, the ALE Originator 2 transmits an ALE including the target identifiers ID1 and ID2 detected in reading periods R7 and R8.

[note N404] Similarly, initial ALEs are transmitted from the ALE Originator 2 to the ALE Concentrator 3 in periods D2 and D3. However, in the ALE Concentrator 3, because the inhibition time I1 has been registered with respect to the ALE Subscriber 1, these initial ALEs are rejected. The ALEs are further transmitted to the ALE Subscriber 1 in periods S2 to S4. However, when the ALE specification designates to notify only different occurrences, no succeeding ALE is transmitted in this case.

[note N405] In a reading period R15, the target object having the target identifier ID1 moves outside the range of the sensor. In this case, the ALE specification has the ID1 as the filter tag identifier, so that the transmission of the ALE is rejected in the ALE Originator 2.

[note N406] In a notification period D4 of initial ALE, an initial ALE including ID2 alone is forwarded to the ALE Concentrator 3, but because any ALE Subscriber 1 desiring ID2 has not been registered, this initial ALE is rejected in the ALE Concentrator 3.

Here, as an example of a method for establishing a link between the ALE Subscriber 1 and the relevant ALE Originator 2, one method using the ALE Concentrator 3 is described above. However, the present invention is not limited to this example. For example, even when a system configuration without an ALE Concentrator 3 is provided, the ALE Subscriber 1 can implement the link between the ALE Subscriber 1 and the relevant ALE Originator 2 by the ALE Subscriber 1 receiving information from the ALE Originator 2 and selecting the relevant ALE Originator 2 on the basis of the information. Alternatively, the ALE Subscriber 1 can implement the above-described link by the ALE Originator 2 receiving a request from the ALE Subscriber 1 and the relevant ALE Originator 2 responding thereto. In this case, in a first stage, the ALE Subscriber 1 must process a large amount of events, but after the relevant ALE Originator 2 has been selected, processing is executed between the ALE Subscriber 1 and the relevant ALE Originator 2, so that the ALE Subscriber 1 does not need to execute a large amount of events from others than the relevant ALE Originator 2.

### Second Embodiment

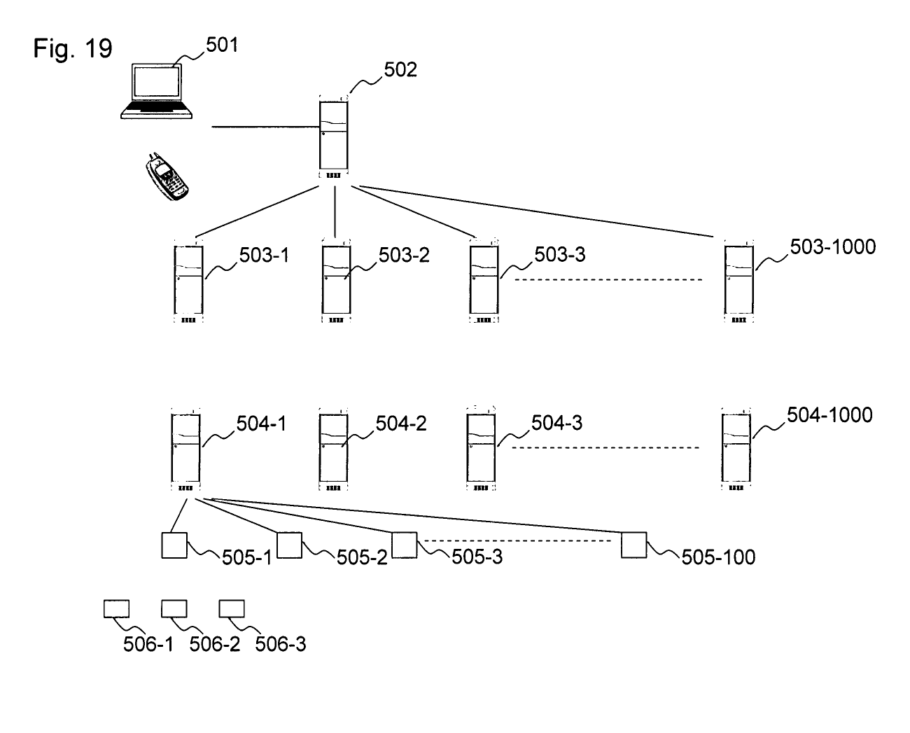

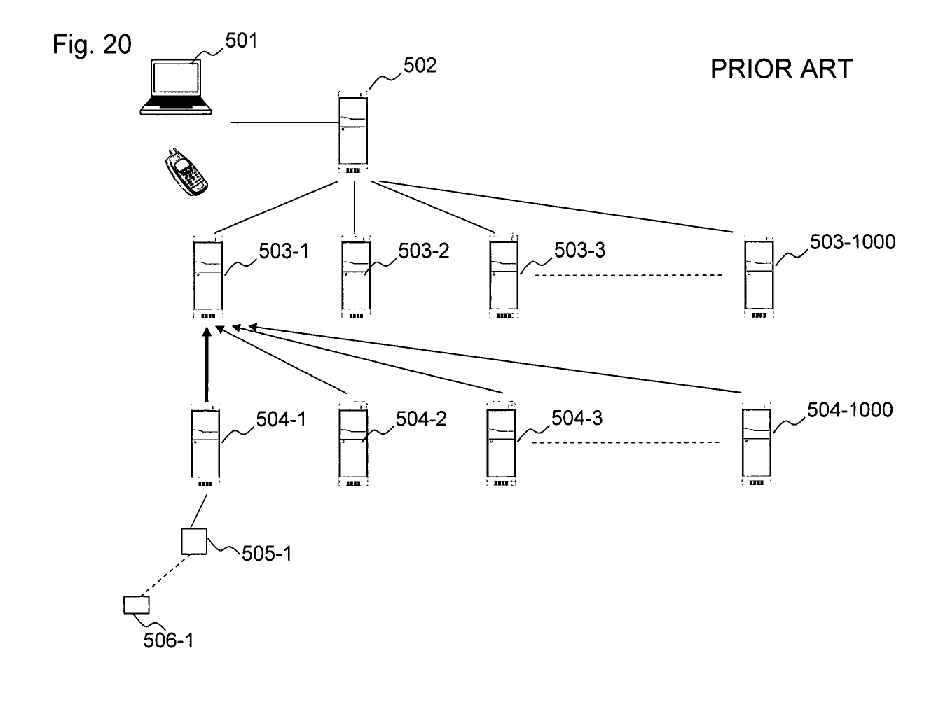

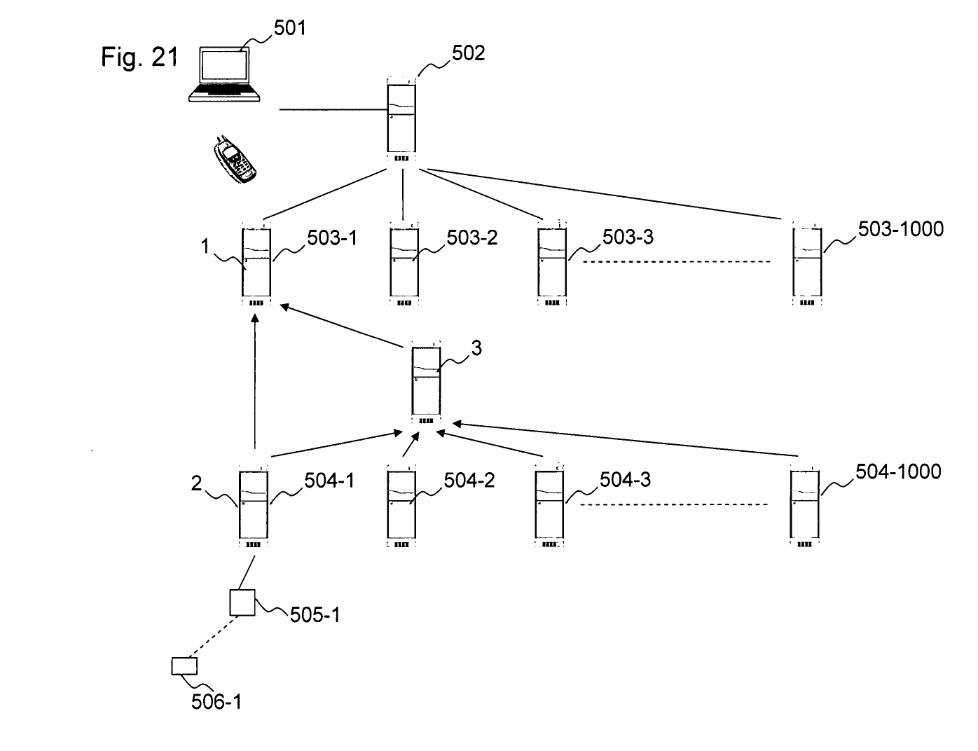

FIG. 21 is a diagram schematically showing the second embodiment of the present invention applied to the same system as FIG. 19. An ASP 503-1 (ALE Subscriber 1) requests the ALE Concentrator 3 to register a target identifier of a user, upon receipt of a registration from the user. The ALE Concentrator 3 collects all sensor events and notifies the ASP of only the events including the target identifier registered in the ALE Concentrator 3 out of the all sensor events. Thus, the ASP becomes capable of collecting information within a requisite minimum range from the sensors upon receipt of the notification of the events. With the present invention applied, events that must be processed by individual ASP per period consist of several events at most for each target user, and the number of filters set up on the sensor side is reduced to a requisite minimum. This allows the throughput of the overall system to be reduced, and enables a sensor network to be provided as a shared infrastructure such that various services can be used for diverse purposes.

### Third Embodiment

In order to describe operations when service using the present invention is executed, an example of the ASP described in the second embodiment will now be explained. The present invention is most effective when service spots extensively exist; the user freely moves in the plurality of service spots; and in addition, the present invention is applied to ones such that another target objects other than the user influence the conduct of the service in the service spots.

Hereinafter, as such an example, a navigating service is described, in which a bus approaching a bus stop is checked whether it can reach the user's destination. The destination display on the bus shows only a rough destination, and whether the bus stops or not at a specific bus stop depends on a bus route. This causes users to withhold from using buses. Bus stops exist in large numbers, and there is a possibility that users may use a bus from every bus stop. Also, since the bus does not arrive at a bus stop on schedule, it is necessary to correctly identify the bus in front of the user.

The bus guidance service described here refers to service for notifying a user of a bus to ride. When a user has reached a bus stop after he/she has registered his/her destination, the user can get information through a mobile phone or the like, about whether he/she should get on the bus in front of him/her. The bus guidance service system comprises a system of a bus guidance service provider that accepts a service request from the user and provides boarding go/no-go information; a system of a public transportation information agency that distributes sensor information from public transportation facilities among various services; and the public transportation facilities of various types of traffic operation companies that provide information to the public transportation information agency. The system of the bus guidance service provider corresponds to the ALE Subscriber 1; the system of the public transportation information agency corresponds to the ALE Concentrator 3; and the public transportation facilities of the traffic operation company correspond to the ALE Originator 2. A bus company, which is one of the traffic operation companies, collects information on RFID tags mounted on mobile phones and buses, using an RFID reader installed on each bus stop.

### [Outline of Service Operations]

### [1] Connection to Public Transportation Information Agency

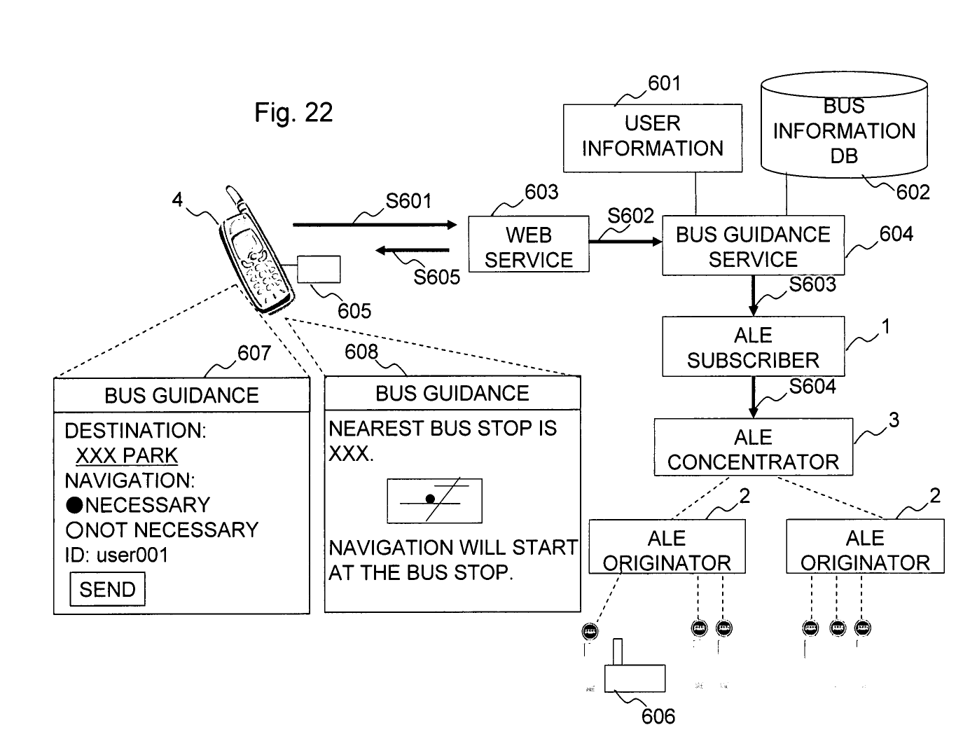

FIG. 22 shows a processing sequence of connection to the public transportation information agency.

[step S601] A user accesses a WEB service 603 of a bus guidance service 604 from a mobile phone 4; inputs a destination in accordance with an input form as shown in a display example 607; and makes a navigation request. At that time, the user also notifies the WEB service 603 of an identifier of an RFID tag 605 mounted on the mobile phone 4 as a user identifier. Here, the user may also input the current location (rough address, or bus stop) of the user. With the mobile phone 4, a technique for grasping a rough location on the basis of the location of a base station may be applied, or with a GPS (global positioning system) receiver, a technique for acquiring positional information by the GPS may be applied. These techniques are not an essential portion of the present invention, but they are applicable by those skilled in the art as appropriate. Description thereof is therefore omitted here.

[step S602] The WEB service 603 notifies the bus guidance service 604 of information inputted into the input form.

[step S603] The bus guidance service 604 records the destination designated by the user, the number of the mobile phone 4 and the user identifier, as user information, and requests the ALE Subscriber 1 to collect the context of the user identifier.

[step S604] The ALE Subscriber 1 connects with the ALE Concentrator 3; designates the user identifier as a target identifier; and requests the ALE Concentrator 3 to forward initial ALEs related to the target identifier.

[step S605] The WEB service 603 notifies the user that it has accepted the service request.

### [2] Detection of User

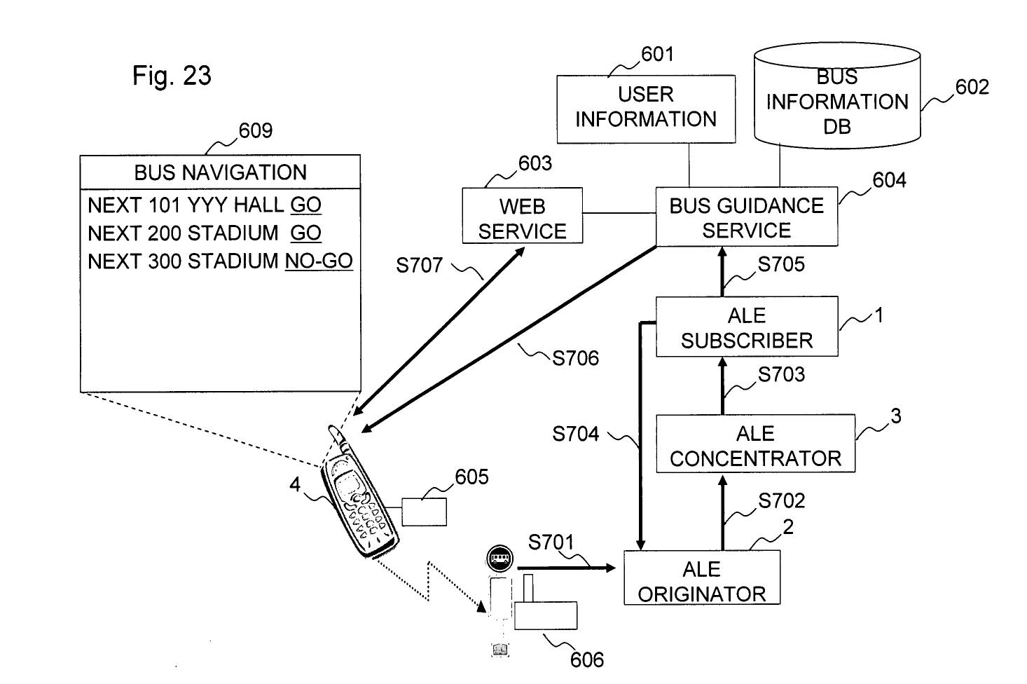

FIG. 23 shows a processing sequence of detection of the user.

[step S701] Upon arrival of the user at a bus stop, an RFID reader 606 at the bus stop reads the user identifier, and notifies, of the sensor event, an ALE Originator 2 serving as a sensor managing server of a bus company.

[step S702] The ALE Originator 2 transmits an initial ALE to the ALE Concentrator 3, in accordance with an initial ALE specification transmitted in advance from the ALE Concentrator 3.

[step S703] Since the ALE Subscriber 1 of the bus guidance service 604 desiring the detected user identifier has been registered in the ALE Concentrator 3, this initial ALE is forwarded to the ALE Subscriber 1 from the ALE Concentrator 3.

[step S704] The ALE Subscriber 1 verifies an Originator attribute included in the initial ALE; ascertains that the transmission source is the bus company; and requests the ALE Originator 2 to register an ALE specification so that the ALE Originator 2 can directly transmit an ALE including the user identifier to the ALE Subscriber 1. The ALE specification includes, e.g., the user identifier and an identifier of an RFID tag mounted on a bus (referred to as a bus identifier).

[step S705] The ALE Subscriber 1 notifies the bus guidance service 604 that the user has been detected at the bus stop.

[step S706] The bus guidance service 604 pushes a uniform resource locator (URL) on the mobile phone 4 to activate a navigator screen.

[step S707] The mobile phone 4 accesses the WEB service 603 on the basis of the pushed URL.

### [3] Navigation including Boarding Go/No-Go Information

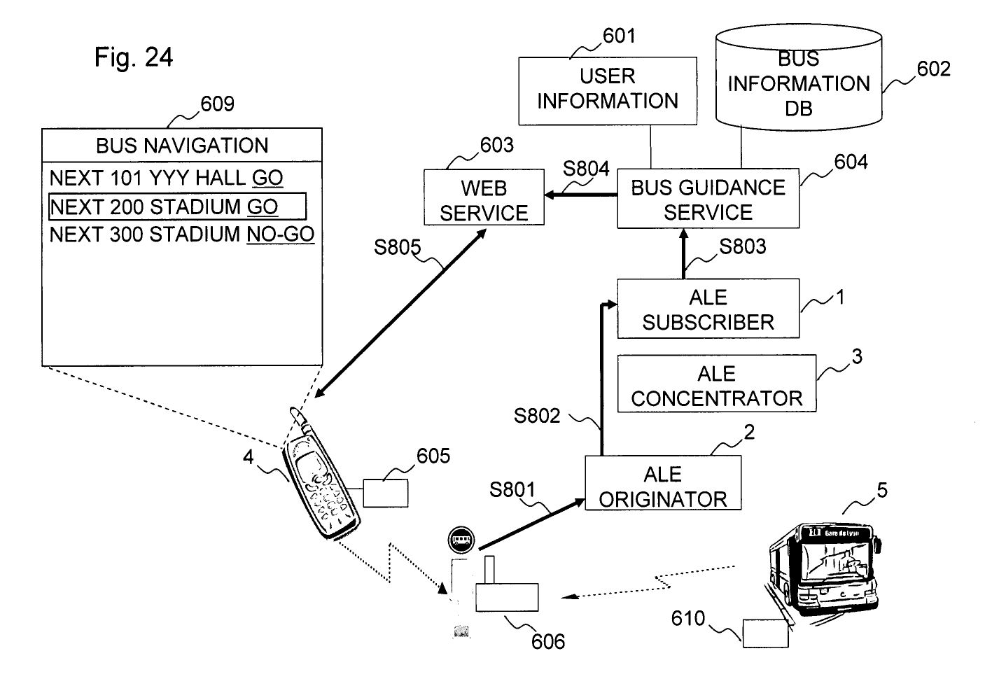

FIG. 24 shows a processing sequence of navigation including boarding go/no-go information.

[step S801] Upon approach of a bus 5 to the bus stop, the RFID reader 606 at the bus stop becomes aware of the approach of the bus 5 by detecting a bus identifier, and transmits a sensor event to the ALE Originator 2. Consequently, the user identifier and the bus identifier are transmitted to the ALE Originator 2.

[step S802] Since the ALE Subscriber 1 desires the detected user identifier, the ALE Originator 2 transmits an ALE including the user identifier and the bus identifier to the ALE Subscriber 1 in accordance with the ALE specification received from the ALE Subscriber 1.

[step S803] The ALE Subscriber 1 notifies the bus guidance service 604 of the bus identifier.

[step S804] The bus guidance service 604 extracts bus information from a bus information database 602 on the basis of the bus identifier, and determines whether the bus stops at the destination of the user. The bus guidance service 604 transmits, to the WEB service 603, information indicating the approach of the bus together with the boarding go/no-go information.

[step S805] The WEB service 603 updates display information (addition of buses, flash display of oncoming bus, etc.).

In this embodiment, ALE Originators 2 and RFIDs may vary from a bus company to another. Alternatively, ALE Originators 2 and RFIDs may be shared among the bus companies, or still alternatively, they may be provided as public infrastructure.

The context information collection system according to the embodiments described above may be implemented in hardware or in computer software. For example, a program for allowing a computer to execute functions of the concentrator connection function 201, the ALE production function 205 and the ALE transmission function 208 shown in FIG. 4 is created so that the ALE originator 2 shown in FIG. 1 can be implemented by loading the program in a memory of the computer and executing the program.

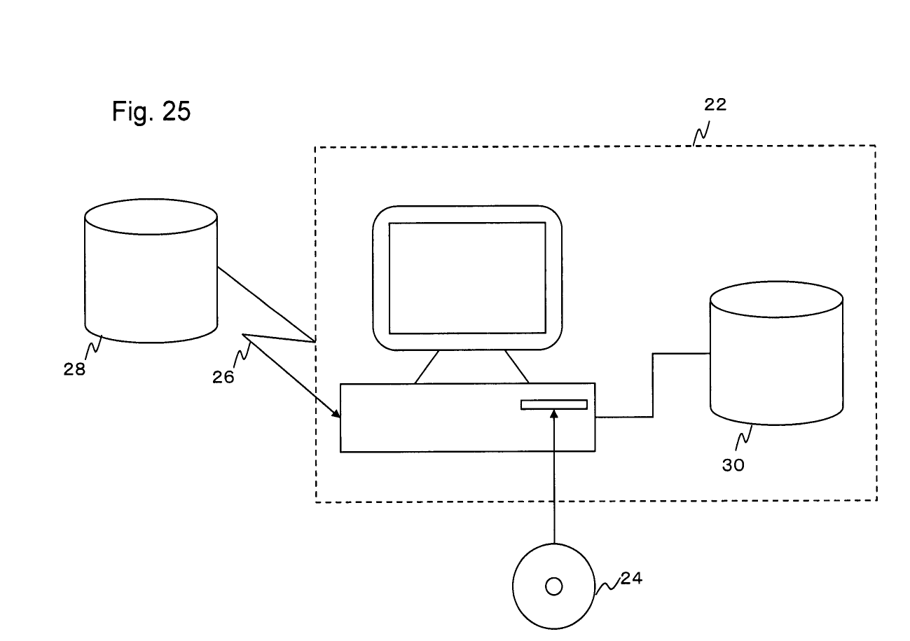

The program for implementing a context information collection system according to the embodiments may be stored in a portable recording medium 24 such as a CD-ROM, a CD-RW, a DVD-R, a DVD-RAM, a DVD-RW, or a flexible disk, a storage device 28 provided at the other end of a communication circuit 26, a storage device such as a hard disk, a RAM, or the like of a computer system 22, or a recording medium 30 of the computer system 22, as shown in FIG. 25. When the program is executed, the program is loaded and executed on a main memory.

The “ALE Subscriber” may be referred to as a “Subscriber”.

The “ALE Originator” may be referred to as an “Originator”.

The “ALE Concentrator” may be referred to as a “Concentrator”.

The “identifier” may be referred to as an “ID”.

Having described the present invention as related to the above-described embodiments, it is believed obvious that the technical range of the present invention is not limited to the range set forth in the embodiments, but various changes or modifications may be made therein. The embodiments subjected to such changes or modifications are also included in the technical range of the present invention. This will be evident from the appended Claims and Summary in the description.

What is claimed is:

1. A system for collecting context information, said system being capable of communicating with a sensor which receives a target identifier transmitted from a target device identified by the target identifier, said system comprising:
an originator for collecting the target identifier received by the sensor and for transmitting a first information related to the collected target identifiers;
a subscriber for searching for a first desired target identifier; and
a concentrator for finding, upon receiving an order from the subscriber, the first desired target identifier among from the target identifiers collected by the originator and for notifying the subscriber of a specific originator which collected the first desired target identifier; wherein
the subscriber orders the specific originator to find a second desired target identifier.

2. The system of claim 1, said first information includes a first target identifier included in the collected target identifiers.

3. The system of claim 2, wherein
the concentrator transmits a first specification specifying a first desired information to the originator; and
the originator transmits the first information in accordance with the first specification to the concentrator.

4. The system of claim 2, wherein
the subscriber transmits a first condition prescribing the first desired target identifier to the concentrator; and
the concentrator determines whether the first target identifier satisfies the first condition.

5. The system of claim 4, wherein
the originator further transmits an originator identifier identifying the originator to the concentrator; and
the concentrator transmits the originator identifier to the subscriber if the first target identifier satisfies the first condition.

6. The system of claim 5, wherein
the subscriber transmits a second condition prescribing a second desired target identifier to the specific originator; and
the specific originator transmits a second information including a second target identifier satisfying the second condition to the subscriber.

7. The system of claim 6, wherein
the second condition includes restriction with regard to time between the receptions of the first target identifier and the second target identifier by the sensor.

8. The system of claim 6, wherein
the subscriber further transmits a second specification specifying a second desired information to the specific originator; and
the specific originator transmits the second information in accordance with the second specification to the subscriber.

9. A method for collecting context information, said method being executed by a system comprising a subscriber, a concentrator, and an originator, said system being capable of communicating with a sensor which receives a target identifier transmitted from a target device identified by the target identifier, said method comprising:
a first ordering step in which the subscriber transmits a first condition prescribing a first desired target identifier to the concentrator;
a collecting step in which the originator collects the target identifier received by the sensor;
an informing step in which the originator transmits a first target identifier included in the collected target identifiers to the concentrator; and
a checking step in which the concentrator determines whether the first target identifier satisfies the first condition.

10. The method of claim 9, further comprising:
a first guiding step in which the concentrator transmits a first specification specifying a first desired information to the originator, wherein
in the informing step, the originator transmits a first information including the first target identifier in accordance with the first specification to the concentrator.

11. The method of claim 9, wherein
in the informing step, the originator further transmits an originator identifier identifying the originator to the concentrator, the method further comprising:
a first reporting step in which the concentrator transmits the originator identifier to the subscriber if the first target identifier satisfies the first condition.

12. The method of claim 11, further comprising:
a second ordering step in which the subscriber transmits a second condition prescribing a second desired target identifier to a specific originator having the originator identifier transmitted from the concentrator; and
a second reporting step in which the specific originator transmits a second target identifier satisfying the second condition to the subscriber.

13. The method of claim 12., wherein
the second condition includes restriction with regard to time between the receptions of the first target identifier and the second target identifier by the sensor.

14. The method of claim 12, further comprising:
a second guiding step in which the subscriber transmits a second specification specifying a second desired information to the specific originator, wherein
in the second reporting step, the specific originator transmits a second information including the second target identifier in accordance with the second specification to the concentrator.

15. A program storage medium readable by a computer system, tangibly embodying a program of instructions executable by the computer system to perform method steps of a method for collecting context information, said computer system comprising a subscriber, a concentrator, and an originator, said computer system being capable of communicating with a sensor which receives a target identifier transmitted from a target device identified by the target identifier, said method comprising:
a first ordering step in which the subscriber transmits a first condition prescribing a first desired target identifier to the concentrator;
a collecting step in which the originator collects the target identifier received by the sensor;
an informing step in which the originator transmits a first target identifier included in the collected target identifiers to the concentrator; and
a checking step in which the concentrator determines whether the first target identifier satisfies the first condition.

16. The program storage medium of claim 15, said method further comprising:
a first guiding step in which the concentrator transmits a first specification specifying a first desired information to the originator, wherein
in the informing step, the originator transmits a first information including the first target identifier in accordance with the first specification to the concentrator.

17. The program storage medium of claim 15, wherein
in the informing step, the originator further transmits an originator identifier identifying the originator to the concentrator, the method further comprising:
a first reporting step in which the concentrator transmits the originator identifier to the subscriber if the first target identifier satisfies the first condition.

18. The program storage medium of claim 17, said method further comprising:
a second ordering step in which the subscriber transmits a second condition prescribing a second desired target identifier to a specific originator having the originator identifier transmitted from the concentrator; and
a second reporting step in which the specific originator transmits a second target identifier satisfying the second condition to the subscriber.

19. The program storage medium of claim 18, wherein
the second condition includes restriction with regard to time between the receptions of the first target identifier and the second target identifier by the sensor.

20. The program storage medium of claim 18, said method further comprising:
a second guiding step in which the subscriber transmits a second specification specifying a second desired information to the specific originator, wherein
in the second reporting step, the specific originator transmits a second information including the second target identifier in accordance with the second specification to the concentrator.
